(19) United States
(12) Patent Application Publication
(10) Pub. No.: US 2012/0169880 A1
(43) Pub. Date: Jul. 5, 2012

(54) Method and system for video-based gesture recognition to assist in access control

(75) Inventor: Jon L. Williamson, Newburyport, MA (US)

(73) Assignee: SCHNEIDER ELECTRIC BUILDINGS LLC, North Andover, MA (US)

(21) Appl. No.: 13/136,621

(22) Filed: Aug. 5, 2011

Related U.S. Application Data
(63) Continuation-in-part of application No. 12/983,028, filed on Dec. 31, 2010.

(51) Int. Cl. H04N 7/18

(52) U.S. Cl. 348/152; 348/143; 348/E07.085

(57) ABSTRACT

The system and method uses video to assist in access control to determine if a person is displaying a position indicating that he/she needs assistance, such as carrying a box, or displaying a position indicating that potential unauthorized entry, such as tailgating, is occurring. The system takes a digital video image and compares the image to a library of images of potential interest. The system takes appropriate action which can include automatically opening the door or notifying an operator, such as a security officer, of the situation.

### CROSS-REFERENCE TO RELATED APPLICATIONS

This application is a continuation-in-part of U.S. patent application Ser. No. 12/983,028 filed on Dec. 31, 2010, which is incorporated herein by reference.

### FIELD OF THE INVENTION

The present invention relates to physical security and access control and more particularly to using video-based recognition to determine both whether to assist certain authorized persons and deter non-authorized persons in relation to access to a physical location.

### BACKGROUND OF THE INVENTION

If a person, such as an employee, is carrying a box into the office or sprained their ankle over the weekend and is on crutches on a Monday morning, the person is at the mercy of a fellow employee to hold open the door. In some conventional systems, the door can have a door assist that is tied to a person's credentials and with a long term need to have the door open automatically and stay open for a period of time. The conventional system ties the person's credentials such as a proximity card to the requirement to provide the door assist.

In addition to the shortcomings related to persons needing assistance, conventional systems have shortcomings that facilitate unauthorized access. For example, tailgating when an operator enters a secured area without being authenticated by following behind someone through an open door. Another example is the unintended request to exit wherein someone on the secured side of a door walks by a passive infrared request-to-exit sensor without the intention to exit, and a third party located on the other side of the door upon hearing the door being unlocked opens the door and enters the secured facility.

### SUMMARY OF THE INVENTION

It has been recognized that video-based recognition systems can supplement a credential-based access system to both assist authorized persons with needs and deter non-authorized or improper access.

In an embodiment of an access control system, such as a video assist access control system, the system has at least one access control device for controlling the flow of items in a physical setting. A control system receives information from the at least one access control device and determines if access is to be granted. At least one camera, such as a video camera, provides a live data feed. The system has a library containing at least one data representation of interest. A mechanism compares the live data feed from the camera to the data representations in the library of interest to obtain comparison metrics. A mechanism determines, based on the comparison metrics, if the live data feed has an image that is sufficiently close to at least one of the data representations of interest. A notification mechanism-notifies an operator that the system has noted a position of interest.

In an embodiment, the position of interest represents a person needing assistance. In an embodiment, the access control device includes a door and a device to control the unlocking of the door, and the system further comprises an automatic door opener for opening a door.

In an embodiment, the person is carrying a package. In an embodiment, the person has crutches.

In an embodiment, the position of interest represents potential improper access. In an embodiment, the position of interest is at least one person tailgating an authorized individual. In an embodiment, the position is at least one person on the other side of the access control device from the request.

In an embodiment, the notification mechanism sends an alarm. In an embodiment, the notification mechanism includes sending a live video feed of at least one camera associated with the access control device.

In a method of determining if assistance is required in relation to an access control device, data, such as video images, is captured in real time from at least one camera. The live video feed from the video camera is compared to the images of positions representing a person needing assistance. It is determined if the live video feed has an image sufficiently close to at least one of the images of a position representing a person needing assistance. The system automatically assists with the opening of a door associated with the access control device.

In a method of assessing access control with a video image according to the invention, an access request is received from an access control device for controlling the flow of items in a physical setting. Information associated with the request is compared with a database. Video images are captured in real time from at least one video camera providing a live video feed associated with the access control device. The video image is compared with a library containing at least one image (a representation) of a position of interest. It is determined if the live video feed has an image sufficiently close to at least one of the images of a position of interest. The system acts if a position of interest has been noted.

In an embodiment, the position of interest represents a person needing assistance. In one embodiment, the access control device includes a door and a device to control the unlocking of the door. The system further comprises an automatic door opener for opening a door. In an embodiment, the person is carrying a package. In an embodiment, the person has crutches.

In one embodiment, the position of interest represents potential improper access. In one embodiment, the position is at least one person tailgating. In one embodiment, the position is at least one person on the other side of the access control device from the request.

In an embodiment, the notification mechanism sends an alarm. In an embodiment, the notification mechanism includes sending a live video feed of at least one video camera associated with the access control device.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a pictorial display of an office building using the video assist access control system according to the invention;

FIG. 2 is an enlarged view of the office building taken at circle 2 in FIG. 1;

FIG. 3 is an enlarged view of the office building taken at circle 3 in FIG. 1;

FIG. 4 is a schematic of a system for a video assist access control system according to the invention; and

FIG. 5 is a schematic of a method of determining if a video assist access control system has noted a position of interest related to potential improper access and/or assistance required.

### PREFERRED EMBODIMENTS OF THE INVENTION

The system and method is an analysis video used in conjunction with an access control system to determine if a person needs assistance or if a person is attempting non-authorized or improper access. For example, the video assist access control system 20 can assist a disabled person through a door. Likewise, the video assist control system 20 can notify an operator of the system if a person is attempting to tailgate or otherwise circumvent an access control system.

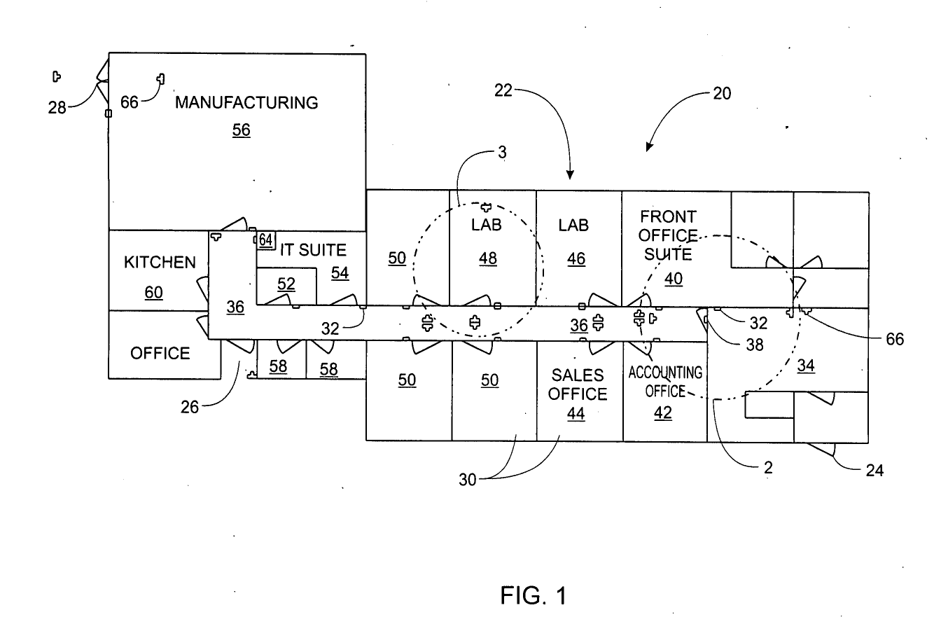

Referring to FIG. 1, a pictorial display of an access control system 20, such as a video assist access control system for a building 22 is shown. In this simplistic representation, the building 22 is shown with a plurality of entrances including a front entrance 24, a side entrance 26, and a back entrance 28. In addition, the building 22 has a plurality of rooms 30 some of which have access control devices 32. In addition, the building 22 has an access control device 32 between a front lobby 34 and a hallway 36; this door is referenced as 38.

It recognized that during the business day certain access control devices 32 may be switched to another mode where the system 20 does not limit access between specific locations such as between the lobby 34 and the hallway 36 or, in the alternative or in addition to the front entrance 24. While the access control devices 32 may be switched to another mode, the video assist may be operational in this other mode as explained in further detail below.

In this embodiment, each employee has a proximity card that is required to open certain doors, such as a front office suite 40, an accounting office 42, a sales office 44, a plurality of labs 46 and 48, a plurality of other offices 50, a facilities office 52, an IT suite 54, and a manufacturing space 56. Other locations such as restrooms 58 and a kitchen 60 do not have an access system. As way of an example, John Employee has a proximity card that grants him access to the accounting office 42, the sales office 44, and the front office suite 40 in addition to the outside doors 24 and 26 and the lobby door 38.

Still referring to FIG. 1, the building 22 has a recording system 64 that records/stores the images from a plurality of cameras 66, such as a video camera for future viewing. The images can be stored in various formats including tape, disk, and memory. In addition to the video assist control system 20 of this invention described in more detail below, the video cameras 66 can used with a duress detection system as described in the “Method and System for Detecting Duress” patent application, patent application Ser. No. 12/983,028 filed on Dec. 31, 2010 listing Jon L. Williamson as inventor and which is incorporated herein by reference.

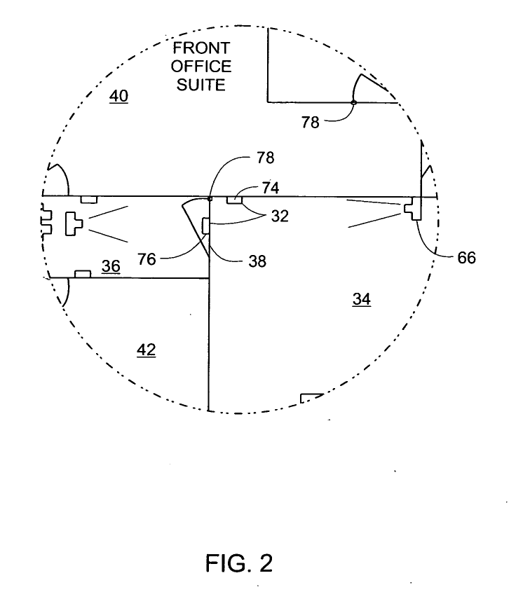

While the component associated with each door or secure access point may vary, for simplicity only two potential arrangements will be described. Referring to FIG. 2, an enlarged view of the door 38 between the front lobby 34 and the hallway 36 is shown. As indicated above, there are several video cameras 66 associated with the door 38. The door has a proximity card reader 74 in the lobby 34. In contrast to a conventional system where a passive infrared request-to-exit sensor 76 in the hallway 36 allows a person to pass through the door 38 by getting in proximity to the door 38, the video assist control system 20 uses input from a camera, such as the video cameras 66, associated with the door 38 to control the output device 78. There is no need to use credentials such as a proximity card to get out of the building 22, that is from the hallway 36 to the lobby 34. It is recognized that the system 20 can have both cameras 66 and passive infrared request-to-exit sensors 76. The building 22 typically has emergency releases that will set off an alarm and allow the door to open if other systems are not working due to various reasons including power loss.

Other doors such as the side entrance 26 and the back entrance 28 have a similar configuration. The use of the side entrance 26 and the door 38 will be described in more detail below with respect to the video assist access control system 20.

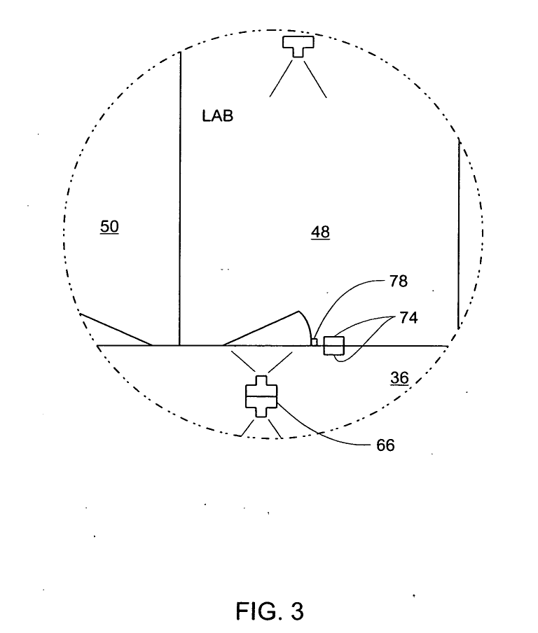

Referring to FIG. 3, an enlarged view of the entrance to the lab 48 from the hall 36 is shown. While not all rooms 30 have video cameras 66, the lab 48 has a camera 66 in which the door is in the field of view. In addition, the door has a proximity card reader 74 on each side of the door. It is the operator's desire to not only limit access to the lab 48, but to track both entrance and egress from the lab 48.

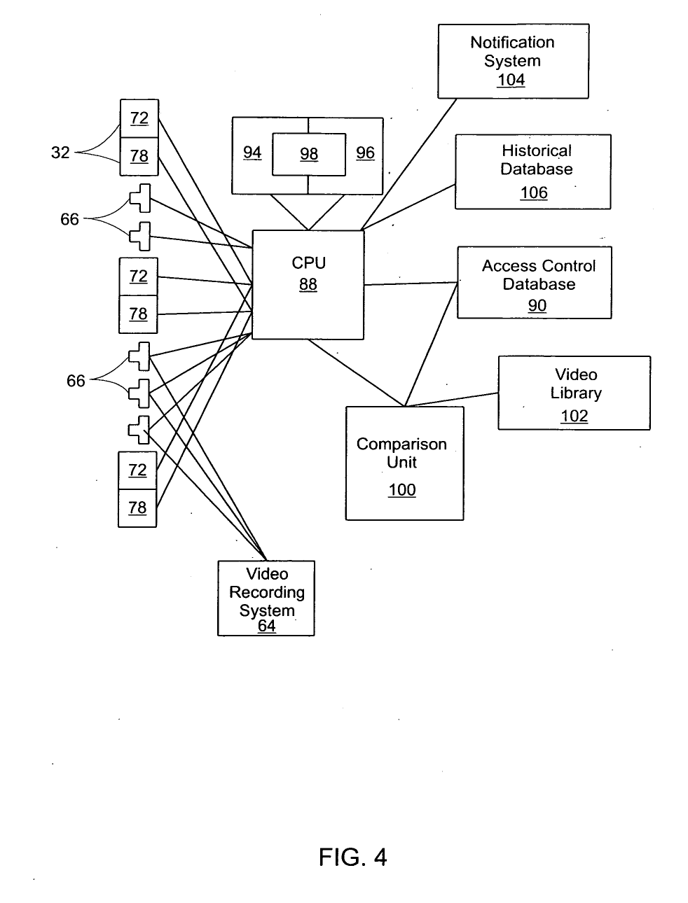

Referring to FIG. 4, a schematic of the video assist access control system 20 for assisting the access control through live video is shown. The video assist access control system 20 has a plurality of access control devices 32 including an input device or mechanism 72, such as a proximity card reader 74 and the passive infrared request-to-exit sensor 76 as seen in FIG. 2. The access control devices 22 also include an access restrictor or output device 78 such as the electronic lock 80 in FIG. 2. The access control device 22 monitors and grants access to locations in conjunction with other components. In order to gain access to a certain physical location, a user needs to provide authentication to the access control device 22 through the input mechanism 72. The authentication can be in various forms including, but not limited to, a proximity card that is placed in proximity to a proximity card reader which is part of the input mechanism 72. Another alternative is a keypad or swipe card reader in which the user either enters their code or swipes their card. Other credential alternatives include RFID, readers, and tags.

The access control devices 22, such as a proximity card, are forms of credentials. Credentials limit access by controlling at least one of three items of have, know, or about. For example, the user would Have a card. A user would Know a PIN. Biometrics is About a user.

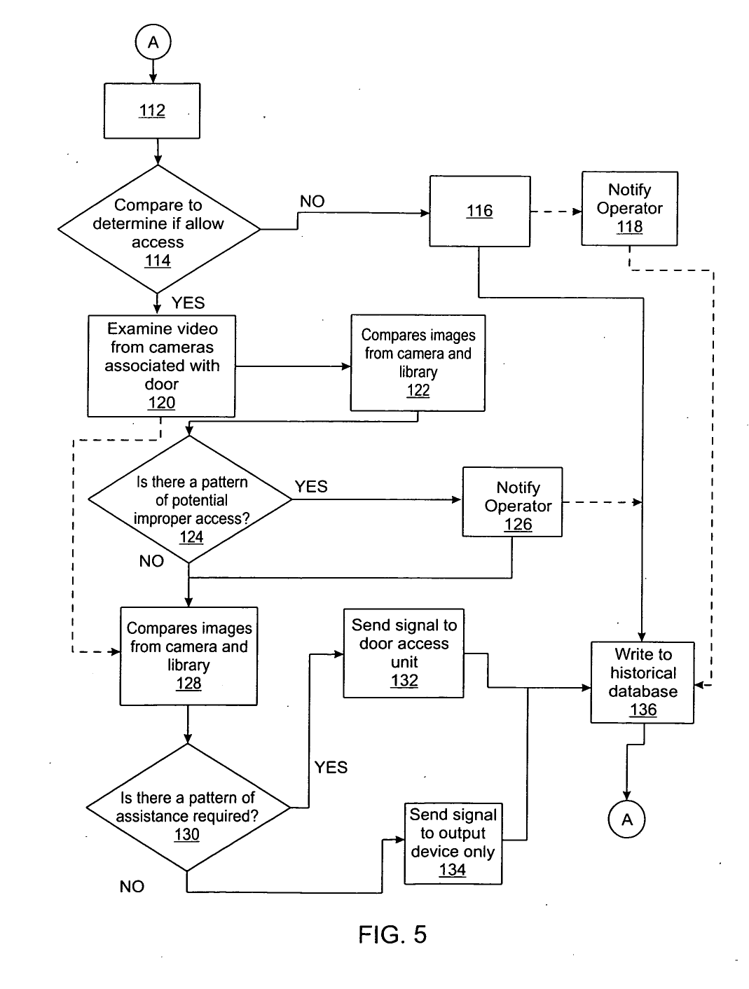

In order to exit certain physical locations, the user needs to do something in order to have the door capable of opening. The user might need to walk into a certain area where the system 20 through the camera 66 and the components described below recognizes the user and signals the output device 78. It is recognized that in a system where there is a camera 66, the door may open independently of a signal tied to the camera; the video assist access control system 20 through a recognition system such as facial recognition system may capture and identify those exiting the lab 48 and record the data as represented by block 136 in FIG. 5.

The video assist access control system 20 has a controller or central processing unit 88 for controlling the video assist access control system 20. The CPU 88 accesses the access control database 90 that contains information related to access privileges and the information received from the input mechanism 72 of the access control device 22 is compared to determine if the access restrictor output device 78 should be set to allow access. The access restrictor output device 78 could be an electronic latch, mechanical latch, or a gate.

Still referring to FIG. 4, the video assist access control system 20 includes an interface device 94 for receiving operator input and a graphical display system 96 for an operator to control the video assist access control system 20. In another embodiment, the interface device 94 is a keyboard and a point of control such as a mouse or tracker ball. In another embodiment, the interface device 94 and the graphical display system 96 are incorporated into one device such as a touch screen 98.

In addition, the video assist access control system 20 has the plurality of video cameras 66 that send a signal to a comparison unit 100. The comparison unit 100 compares the live video with stored patterns in a video library 102. The CPU 48 in addition to communicating with the comparison unit 100 accesses the video assist access control library 102 that contains information related to specific patterns to which the video received from the video cameras 66 is compared to determine if an individual needs assistance to pass through a door or if there is potential improper access.

The video assist access control system 20 also has a notification system 104 that notifies an operator if the video assist access control system 20 determines that there is potential improper access. As indicated below, the notification can take various forms.

Referring to FIG. 5, a schematic of a method of determining if assistance should be given or notification should occur because of potential improper access is shown. The system 20 receives a request to grant access to a specific location from an input mechanism for a particular door 62 in the building 22 as seen in FIGS. 1 and 2 and as represented by block 112 as seen in FIG. 5. The system 20 compares the request for authorization as stored in the access database 90 as seen in FIG. 4 and represented by decision diamond 114. If the authorization is not proper, the system does not grant access through the output device 78 such as the electronic lock 80, as represented by block 116. In one embodiment, the system 20 notifies an operator through the graphic display 96 as seen in FIG. 4 in real time if someone attempts to access a location not authorized, and as represented by block 118 in FIG. 4.

In contrast to a conventional system in which the authorization is proper, in which the system grants access to the user by sending a signal through the output device 78, the video assist access control system 20 has additional steps. While there are additional steps, a typical person at the door 62 will not see a delay or appreciate the additional steps.

If access should be allowed, as represented by decision diamond 114, the video assist access control system 20 gathers images from at least one video or data feed such as video cameras 66 as represented by block 120. The image is placed in a digital form which is typically done nowadays by the video cameras 66.

The video assist access control system 20 compares the digital images with potential improper access patterns retained in the video library 102 as represented by block 122. The comparison unit 100 determines if there is a potential improper access pattern shown as represented by decision diamond 124. If no pattern is shown as represented by the “no” branch, then the process proceeds to the step described in the third paragraph below. If a potential improper access pattern is noted as represented by the “yes” branch, then a notification is issued by the notification system 104 of the system 20 as represented by block 126.

While stated as comparing images to image, it is recognized by one skilled in the art that cameras and computer vision use mathematical algorithms and convert points in the image, such as a human face or the position of arms and hands, to geometrical relationships. The system is capable of proportionally adjusting the relationship to recognize objects and/or arrangements (position) even if the object and/or arrangement is located in different positions in the image of the camera or distance from the camera.

The patterns that will cause notification can be designated by the operator of the system 20. The patterns can be selected from a catalog in the video library 102. In addition or in the alternative, the operator can with the assistance of the system 20 add specific patterns discussed below.

Regardless if potential improper access is noted, the system 20 compares the digital images with patterns of assistance required retained in the video library 102 as represented by block 128. The comparison unit 100 determines if there is an assistance required pattern shown as represented by decision diamond 130.

If an assistance required pattern is shown as represented by the “yes” branch, a signal is sent to the automatic door opener 82 and the output device 78 such as the electronic lock 80 in FIG. 2 as represented by block 12 in FIG. 5. If no pattern of assistance is noted as represented by the “no” branch, a signal is sent to the output device 78 such as the electronic lock 80 in FIG. 2, but not to the automatic door opener 82, as represented by block 134 in FIG. 5. The system 20 also writes to the historical database 106, as seen in FIG. 4, of what occurred as represented by block 136.

Referring back to FIG. 2, if a person is on crutches or is carrying a package and they desire to pass through the door 38, the video assist access control system 20 receives a signal from the proximity card reader 74, as represented by block 112 in FIG. 5. When the system 20 determines that access should be allowed as represented by decision diamond 114, the system examines the video from cameras 68 associated with the door 36 as represented by block 120. For this example, the issue of potential improper access 124 is not examined. The image is compared with images from the library 102, as seen in FIG. 4, and represented by block 128. Examples of possible images include crutches, position of the person, a wheelchair, and position of person's arms and objects.

If the system 20 determines that “assistance is required” as represented by decision diamond 130, a signal is sent to the automatic door opener 82 and the output device 78 such as the electronic lock 80 in FIG. 2 as represented by block 12 in FIG. 5.

In addition, the operator may desire to have the system notify the operator if the automatic door assist is used for a person not coded within the access control database 90, as seen in FIG. 4, for needing automatic door assist. The operator may want to follow-up to determine if the access control database 90 should be updated. In addition, video could be examined to determine potential security issues regarding large packages entering or exiting the building.

As noted previously, certain doors such as door 38 in FIG. 2 may be switched to another mode in which credentials may not be required to pass through the door during normal business hours. The video assist access control system 20 can still be used to assist in opening the door. The system 20 would constantly compare images from the camera to the library as represented by block 128. If a pattern of assistance is noted as represented by decision diamond 130, the automatic door opener 82 could open the door 38.

Referring back to FIG. 1, it is noted that the side entrance 26 is on the hallway 36 in the office building 22. In a conventional system, a person in the building could walk down the hallway 30 and pass by the passive infrared request-to-exit sensor 76 for the door without the intention to exit the building 22. In that the person in the building 22 had no intention to exit, the person might not notice if someone, a third party, is outside the building attempting to enter the building 22.

In this situation, the video assist access system 20 receives a request to grant access to a specific location from an input mechanism for a particular door 62 in the building 22. The input mechanism in this case could either be a passive infrared request-to-exit sensor 76 associated with the side entrance 26 in FIG. 1 or the video camera 36 and as represented by block 112 as seen in FIG. 5. While the system 20 compares the request for authorization as stored in the access database 90 as seen in FIG. 4 and represented by decision diamond 114, in the case of the passive infrared request-to-exit sensor 76, the authorization would be approved. In conventional systems the output device 78 such as the electronic lock 80 would receive the signal to open and that would be the end of the process.

If the system 20 uses the video camera 36, the system 20 would not automatically grant authorization as represented by decision diamond 114, but rather as explained below the system 20 would determine based on where a person's are located if a signal should be sent to the output device 78 and/or if the operator should be notified as represented by block 126 in FIG. 5.

In contrast to the conventional system, the video assist access control system 20 has additional steps. The video assist access control system 20 gathers images from the video cameras associated with the side entrance 26 as represented by block 120. The number of video cameras can vary, but in the embodiment shown in FIG. 1 there are at least three potential cameras.

The video assist access control system 20 compares the digital images with potential improper access patterns retained in the video library 102 as represented by block 122. The comparison unit 100 determines if there is a potential improper access pattern shown as represented by decision diamond 124. In this situation, the comparison unit 100 recognizes that the request came from inside the building, the passive infrared request-to-exit sensor 76, but the person is located outside of the building. The system 20 will notify the operator 126. Depending on the criteria established by the operator, the signal to the output device 78 to open the door may or may not be sent as represented by the dash line from block 126 in FIG. 5.

The door assist and the automatic door opener 82 will not be described in this embodiment. It is recognized that the door assist and the automatic door opener 82 may not be on every door and the video assist access control system 20 may be used for potential improper access in certain situations.

Referring back to FIG. 3, as indicated above the lab 48 has a proximity card reader 74 on each side of the door. The operator of the system 20 wants to control who is in the lab 48 and also have accurate information as to who is in the lab 48 at what times. The operator therefore has a proximity card reader 74 at the door both outside the room (the lab 48) and inside the room. A person is required to scan their card both to enter the room (the lab 48) and exit the room. While persons having access to the lab 48 have been instructed that they are required to use their credentials both on entering and exiting, there is a likelihood that there will be tailgating. This is the situation when a person enters a secured area without being authenticated by following behind someone while the door is unlocked and open. The person who is authenticated may or may not know that a person is tailgating. In a situation like the lab 48, the person who is authenticated likely is aware of the tailgater.

If the video assist access control system 20 receives a request to grant access to a specific location from an input mechanism for a particular door 62 in the building 22, such as from a proximity card reader 74 from either side of the door of the lab 48 as seen in FIGS. 1 and 3 and as represented by block 112 as seen in FIG. 5, the system 20 compares the request for authorization as stored in the access database 90 as seen in FIG. 4 and represented by decision diamond 114. If access should be allowed, as represented by decision diamond 114, the video assist access control system 20 gathers images from video cameras both in the hallway 36 and the lab 48 associated with the door as seen in FIG. 3 and as represented by block 120.

The video assist access control system 20 compares the digital images with potential improper access patterns retained in the video library 102 as represented by block 122. The comparison unit 100 determines if there is a potential improper access pattern shown as represented by decision diamond 124. The system 20 can determine the number of persons passing through the door related to the number of credentials scanned at the proximity card reader 74.

In addition to counting the number of humans entering or exiting a space, in certain embodiments the system 20 can also use facial recognition software to determine if the credentials are associated with the person entering or exiting the lab 48. Therefore even if one credential is scanned and one person enters the lab 48, the system 20 through the video camera 66, the comparison unit 100, and the video library 102 may determine that a potential intrusion is occurring. In this situation, the system 20 could notify the operator by sending a picture of the person associated with the proximity card used and the video of the person entering or exiting the lab 48.

If for example three people leave the lab 48 using only one person's credentials, and the system 20 determines that the persons were authorized to be in the lab 48, the system 20 may notify the three people through the notification system 104 simply by sending an e-mail reminding them of the entrance/exit policy in addition to sending information to the operator.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

It is recognized that while FIG. 1 shows the video typically stored on site, it may be typical to store video remotely in a “cloud” facility.

It is recognized that the system can be used for other access events that go undetected or misinterpreted due to the limitations of the conventional systems. For example, the video assist access control system 20 can differentiate between a door left open versus a door intentionally propped open. Although both conditions may be considered events to detect and alarm against, it is important to distinguish between the two. A door intentionally propped open can be a deliberate violation of policy, yet a condition that may be resolved once the person who propped the door is finished. A door left open may not be a deliberate act. With a door left open event, the user may have simply forgotten to close the door or the mechanical door closer is not working properly. Here the door is less likely to be closed by the one who left it opened. Local policy may result in different actions for both closing the door properly and action taken with respect to the user who caused the door not to close as it should.

In addition and referring back to the third example, that related to the lab 98, the system 20 in addition to noting tailgates, can detect authorized door openings but without entry. For example, a person scans their proximity card and opens the door but fails to walk through the door into the lab 98. The video assist access control system 20 can determine that this has occurred in real time, in contrast to the conventional system.

What is claimed:

1. An access control system comprising:
at least one access control device for controlling the flow of items in a physical setting;
a control system for receiving information from the at least one access control device and determining if access is to be granted;
at least one camera providing a live data feed;
a library containing at least one data representation of interest;
a mechanism for comparing the live data feed from the camera to the data representations in the library of interest to obtain at least one comparison metrics;
a mechanism for determining based on the at least one comparison metric if the live data feed is sufficiently close to at least one of the data representations of interest; and
a notification mechanism for notifying that the system has noted a position of interest.

2. An access control system of claim 1 wherein the data representation of interest represents a person needing assistance.

3. An access control system of claim 2 wherein the access control device includes a door and a device to control the unlocking of the door, and the system further comprises an automatic door opener for opening a door.

4. An access control system of claim 1 wherein the data representation of interest represents potential improper access.

5. An access control system of claim 4 wherein the position is at least one person tailgating.

6. An access control system of claim 4 wherein the position is at least one person on the other side of the access control device from the request.

7. An access control system of claim 1 wherein the notification mechanism sends an alarm.

8. An access control system of claim 1 wherein the at least one camera is at least one video camera and the notification mechanism includes sending a live video feed of at least one video camera associated with the access control device.

9. A method of determining if assistance is required in relation to an access control device comprising:
capturing data feed in real time from at least one camera;
comparing the data feed from the camera to a library containing at least one data representation of a person needing assistance;
determining if the live data feed has an image sufficiently close to at least one of the data representations of a position representing a person needing assistance; and
automatically assisting with the opening of a door associated with the access control device.

10. A method of claim 9 wherein the person is carrying a package.

11. A method of claim 9 wherein the person has crutches.

12. A method of assessing access control with a video image comprising:
receiving an access request from an access control device for controlling the flow of items in a physical setting; comparing information associated with the request with a database;
capturing video images in real time from at least one video camera providing a live video feed associated with the access control device;
comparing the video image with a library containing at least one data representation of a position of interest;
determining if the live video feed has an image sufficiently close to at least one of the images of a position of interest; and
acting if a position of interest has been noted.

13. A method of claim 12 wherein the position of interest represents a person needing assistance.

14. A method of claim 13 wherein the access control device includes a door and a device to control the unlocking of the door, and the system further comprises an automatic door opener for opening a door.

15. A method of claim 14 wherein the person is carrying a package.

16. A method of claim 14 wherein the person has crutches.

17. A method of claim 12 wherein the position of interest represents potential improper access.

18. A method of claim 17 wherein the position is at least one person tailgating.

19. A method of claim 17 wherein the position is at least one person on the other side of the access control device from the request.

20. A method of claim 12 wherein the notification mechanism sends an alarm.

21. A method of claim 12 wherein the notification mechanism includes sending a live video feed of at least one video camera associated with the access control device.

22. A computer-readable medium comprising computer-readable instructions tangibly stored on the computer-readable medium, wherein the computer-readable instructions are executed by at least one computer processor to implement a method for assessing access control, the method comprising:
receiving an access request from an access control device for controlling the flow of items in a physical setting;
comparing information associated with the request with a database;
capturing images in real time from at least one camera providing a live data feed associated with the access control device;
comparing the data feed with a library containing at least one data representation of interest to obtain comparison metrics;
determining based on the comparison metrics if the live data feed has data sufficiently close to at least one of the data representations of interest; and
acting if a data representation of interest has been noted.

23. A computer-readable medium of claim 22 wherein the position of interest represents a person needing assistance.

24. A computer-readable medium of claim 23 wherein the access control device includes a door and a device to control the unlocking of the door, and the system further comprises an automatic door opener for opening a door.

25. A computer-readable medium of claim 22 wherein the position of interest represents potential improper access.

26. A computer-readable medium of claim 25 wherein the position is at least one person tailgating.

27. A computer-readable medium of claim 25 wherein the position is at least one person on the other side of the access control device from the request.
